(19) United States
(12) Patent Application Publication
(10) Pub. No.: US 2007/0279330 A1
(43) Pub. Date: Dec. 6, 2007

(54) Plasma display apparatus

(75) Inventors: Seong Nam Ryu, Busan-si (KR); Woo Gon Jeon, Gumi-si (KR); Sang Min Hong, Seoul (KR); Woo Tae Kim, Yongin-si (KR); Kyung A. Kang, Busan-si (KR); Jeong Hyun Hahm, Seoul (KR); Jae Sung Kim, Gumi-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/704,277

(22) Filed: Feb. 9, 2007

(30) Foreign Application Priority Data
May 30, 2006 (KR) 10-2006-0048817

(51) Int. Cl. G09G 3/28

(52) U.S. Cl. 345/67

(57) ABSTRACT

The present invention relates to a plasma display apparatus, which includes a front substrate; a first, a second electrode formed on the front substrate; a rear substrate that is faced with the front substrate; a third electrodes formed on the rear substrate; a first barrier rib formed in parallel with the third electrodes; and a discharge cell that is partitioned by the first barrier rib, wherein at least one of the first and the second electrode is formed with one layer, wherein, among a plurality of discharge cells, the distance between the first barrier ribs partitioning the first discharge cell is different from the distance between the first barrier ribs partitioning the second discharge cell radiating a different color with the first discharge cell. Accordingly, the manufacturing cost can be reduced by removing the transparent electrode of ITO, the color temperature and the luminance efficiency can be improved with the asymmetric size of R, G, B discharge cell.

This application claims the benefit of Korean Patent Application No. 10-2006-0048817 filed on May 30, 2006, which is hereby incorporated by reference for all purposes as if fully set forth herein.

### BACKGROUND OF THE INVENTION

1. Field of the Invention

The present invention relates, in general, to a plasma display apparatus including a plurality of discharge cells that respectively radiate a different color; a first electrode for generating the maintenance discharge in the discharge cell; a front substrate in which a second electrode and a dielectric layer are formed; and a rear substrate in which a plurality of first barrier ribs for partitioning the discharge cells are formed; a line portion formed in the direction intersecting with a third electrode; a protrusion protruded from the line portion; wherein the rear substrate includes a third electrode formed in parallel with the first barrier rib, wherein at least one of the first and the second electrode is formed with one layer, while the manufacturing cost can be reduced, and the contrast and the luminance of the screen can be improved by increasing the color temperature since the structure where the transparent electrode of ITO is removed can be obtained by differently forming the size of the discharge cell classified by the radiating color.

2. Description of the Related Art

A plasma display panel is an apparatus for displaying an image including a characteristic and a graphic by performing a discharge through applying a predetermined voltage to electrodes arranged in a discharge space, and by exciting the phosphor with the plasma generated in the gaseous discharge time. The plasma display panel has an advantage in that a large size, a light weight and a plane thin shaping are facilitated, the wide viewing angle to the up rear left right can be provided, and the full-color and the high luminance can be implemented.

FIG. 1 is a drawing showing the structure of a plasma display panel of the related art. Referring to FIG. 1, as to a plasma display apparatus, a front panel 100 and a rear panel 110 is disposed in parallel with a constant distance. On the front panel 100, a plurality of sustain electrode pairs are disposed on a front substrate 101 where an image is displayed, when the sustain electrode pair is comprised of a scan electrode 102 and a sustain electrode 103. On the rear panel 100 which is a backside, a plurality of address electrodes intersecting with the plurality of sustain electrode pairs are disposed on a rear substrate 111.

The front panel 100 is comprises of a scan electrode 102 including a transparent electrode 102a, 103a and a bus electrode 102b, 103b, and a sustain electrode 103 while the scan electrode 102 and the sustain electrode 103 form a pair and a transparent electrode 102a, 103a is made of a transparent Indium Tin Oxide ITO. The scan electrode 102 and the sustain electrode 103 are covered with a front dielectric layer 104. The protective layer 105 is formed on the front dielectric layer 104 so as to protect the front dielectric layer 104 from the sputtering of the charged particles generated in the gaseous discharge time and enhance the emission efficiency of the secondary electron.

The rear panel 110 includes a barrier rib 112 for partitioning a discharge cell. A plurality of address electrodes 113 are arranged in parallel with the barrier rib 112. On the address electrode 113, Red R, Green G, and Blue B phosphors 114 are coated. A rear dielectric layer 115 is formed between the address electrode 113 and the phosphors 114.

In the meantime, the transparent electrodes 102a, 103a comprising the scan electrode 102 or the sustain electrode 103 is made of ITO which is expensive. Transparent electrode 102a, 103a causes the raising of the manufacturing cost of the plasma display panel. Therefore, manufacturing the plasma display panel which can obtain the sufficient color matching function and the driving characteristic for a user while decreasing the manufacturing cost is requested in recent days.

### SUMMARY

Accordingly, the present invention has been made in view of the above problems occurring in the prior art, and it is an object of the present invention to provide a plasma display apparatus capable of improving the flickering of the display image, the spot generation, the luminance and the color temperature, reducing the manufacturing cost by eliminating the transparent electrode made of ITO.

To achieve the above object, according to an aspect of the present invention, there is provided a plasma display apparatus, including a front substrate; a first, a second electrode formed on the front substrate; a rear substrate that is faced with the front substrate; a third electrodes formed on the rear substrate; a first barrier rib formed in parallel with the third electrodes; and a discharge cell that is partitioned by the first barrier rib, wherein at least one of the first and the second electrode is formed with one layer, wherein, among a plurality of discharge cells, the distance between the first barrier ribs partitioning the first discharge cell is different from the distance between the first barrier ribs partitioning the second discharge cell radiating a different color with the first discharge cell.

According to an aspect of the present invention, at least one of the plurality of the first, the second electrode comprises: a line portion formed in the direction intersecting with the third electrode; and a protrusion protruded from the line portion.

The plasma display apparatus according to an aspect of the present invention further comprises a front dielectric layer covering the first, the second electrode, wherein at least one of the first and the second electrode is darker than the front dielectric layer.

The distance between the first barrier ribs partitioning the first discharge cell is shorter than the distance between the first barrier ribs partitioning the second discharge cell.

The distance between the first barrier ribs partitioning the second discharge cell ranges from 1.01 times to 1.2 times of the distance between the first barrier ribs partitioning the first discharge cell.

The distance between the first barrier ribs partitioning the second discharge cell ranges from 1.03 times to 1.09 times of the distance between the first barrier ribs partitioning the first discharge cell.

The first discharge cell is a cell radiating a red light, and the second discharge cell is a cell radiating a green light or a blue light.

The line portion is two or more, and the distance between the two line portion which are adjacent each other among the two or more line portions ranges from 80 μm to 120 μm.

The protrusion forms at least one closed loop.

The protrusion is two or more.

A plasma display apparatus according to another aspect of the present invention comprises a front substrate; a first, a second electrode formed on the front substrate; a rear substrate that is faced with the front substrate; a third electrodes formed on the rear substrate; a first barrier rib formed in parallel with the third electrodes; and a discharge cell that is partitioned by the first barrier rib, wherein at least one of the first and the second electrode is formed with one layer, wherein the distances between the first barrier ribs partitioning a first discharge cell, a second discharge cell, and a third discharge cell respectively are different each other, when the first discharge cell is arranged to be adjacent each other among the discharge cells, the second discharge cell radiates a different color with the first discharge cell, and the third discharge cell radiates a different color with the first discharge cell and the second discharge cell.

According to another aspect of the present invention, the distance between the first barrier ribs partitioning the first discharge cell is shorter than the distance between the first barrier ribs partitioning the second discharge cell.

The distance between the first barrier ribs partitioning the second discharge cell is shorter than the distance between the first barrier ribs partitioning the third discharge cell.

The first discharge cell is a cell radiating a red light, the second discharge cell is a cell radiating a green light, and the third discharge cell is a cell radiating a blue light.

The distance between the first barrier ribs partitioning the first discharge cell ranges from 0.80 times to 0.99 times of the distance between the first barrier ribs partitioning the second discharge cell.

The distance between the first barrier ribs partitioning the third discharge cell ranges from 1.01 times to 1.2 times of the distance between the first barrier ribs partitioning the second discharge cell.

According to another aspect of the present invention, at least one of the plurality of the first, the second electrode comprises: a line portion formed in the direction intersecting with the third electrode; and a protrusion protruded from the line portion.

The plasma display apparatus according to another aspect of the present invention further comprises a front dielectric layer covering the first, the second electrode, wherein at least one of the first and the second electrode is darker than the front dielectric layer.

The protrusion is two or more.

A plasma display apparatus according to further aspect of the present invention comprises: a front substrate; a first, a second electrode formed on the front substrate; a rear substrate that is faced with the front substrate; a third electrodes formed on the rear substrate; a first barrier rib formed in parallel with the third electrodes; and a discharge cell that is partitioned by the first barrier rib, wherein at least one of the first and the second electrode is formed with one layer, wherein, among a plurality of discharge cells, the distance between the first barrier ribs partitioning the first discharge cell is different from the distance between the first barrier ribs partitioning the second discharge cell radiating a different color with the first discharge cell, and the aperture ratio in an effective display region that is formed by the first discharge cell and the second discharge cell ranges from 25% to 45%.

### BRIEF DESCRIPTION OF THE DRAWINGS

The present invention will be described in detail with reference to the following drawings in which like numerals refer to like elements. The accompany drawings, which are included to provide a further understanding of the present invention and are incorporated in and constitute a part of this specification, illustrate embodiments of the present invention and together with the description serve to explain the principles of the present invention. In the drawings:

FIG. 1 is a drawing showing the structure of a plasma display panel of the related art.

FIG. 2 is a drawing showing an embodiment of the structure of a panel equipped in a plasma display apparatus according to the present invention.

FIG. 3 is a drawing showing the embodiment of the electrode arrangement of a plasma display panel.

FIG. 4 is a cross-sectional view of a first embodiment of the electrode structure of a plasma display panel according to the present invention.

FIG. 5 is a perspective view showing a second embodiment of a plasma display panel according to the present invention.

FIG. 6a to FIG. 15b are a cross-sectional view showing embodiments of the electrode structure of a plasma display panel according to the present invention.

FIG. 16 to FIG. 18 are a drawing showing embodiments of the electrode structure of a plasma display panel according to the present invention.

FIG. 19 is a drawing showing an embodiment of the method in which a frame of an image of a plasma display panel is time-divided into a plurality of subfields for driving.

FIG. 20 is a waveform diagram showing an embodiment of driving signals for driving a plasma display panel.

### DETAILED DESCRIPTION OF THE EMBODIMENTS

Preferred embodiments of the present invention will be described in a more detailed manner with reference to the drawings.

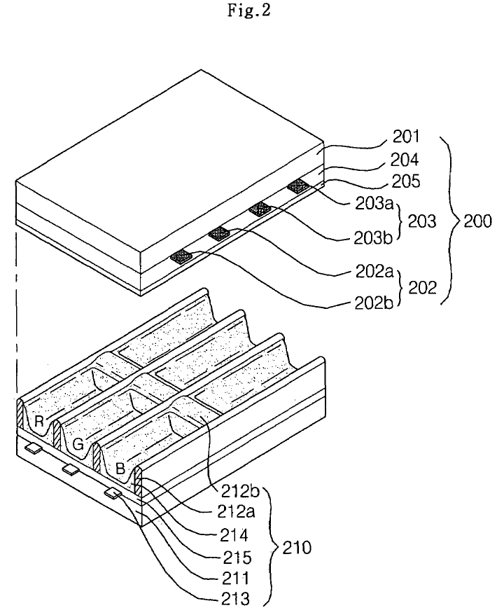

Hereinafter, FIG. 2 is a drawing showing an embodiment of the structure of a panel equipped in a plasma display apparatus according to the present invention.

Referring to FIG. 2, the plasma display panel includes a front panel 200 and a rear panel 210 coalesced with a predetermined gap.

The front panel 200 includes a sustain electrode pair 202, 203 which is formed on a front substrate 201 with forming a pair. According to a function, the sustain electrode pair 202, 203 are classified into a scan electrode 202 and a sustain electrode 203. The sustain electrode pair 202, 203 is covered with a front dielectric layer 204 that limits the discharge current and insulates between the electrode pair. A passivation layer 205 is formed on the top of the front dielectric layer 204, thereby, the front dielectric layer 204 is protected from the sputtering of the charged particles generated during the gaseous discharge and the emission efficiency of the secondary electron can be enhanced.

On the rear panel 210, a barrier rib 212 partitioning a plurality of discharge spaces, that is, a discharge cell is formed on the lower substrate 211. Further, an address electrode 213 is arranged in the direction intersecting with sustain electrode pair 202, 203. A phosphor 214 which is light-emitted by the ultraviolet ray generated during the gaseous discharge time to generate a visible light is coated onto the surface of the barrier rib 212 and the rear dielectric layer 215.

At this time, the barrier rib 212 is comprised of a column barrier rib 212a developed into the direction in parallel with the address electrode 213, and a row barrier rib 212b developed into the direction intersecting with the address electrode 213, which divides the discharge cell physically and prevents the ultraviolet ray generated by a discharge and the visible light from being leaked out into the adjacent discharge cell.

In this way, the inactive gas containing a main gas including Ne, He, or the mixed gas Ne+He, and a small amount of xenon are filled in the discharge cell surrounded by the barrier rib 212a, 212b. At this time, it is preferable that the pressure of the gas in the panel ranges from 350 Torr to 500 Torr. A proper amount of gas, in that case, for enhancing the discharge efficiency is filled, and the difficulty of manufacturing due to the gas pressure in the panel manufacturing processing is removed and can be readily manufactured.

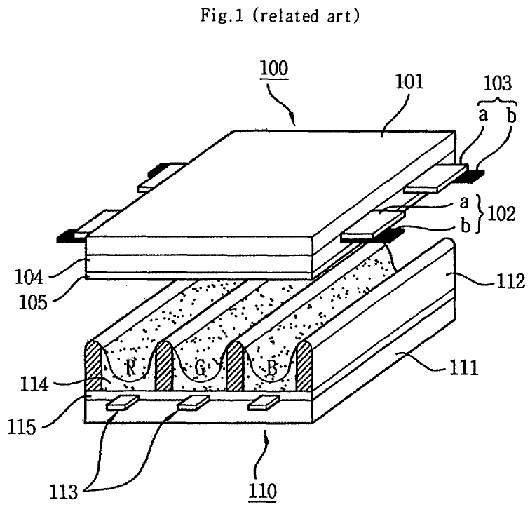

Further, in the plasma display panel according to an embodiment of the present invention, the sustain electrode pair 202, 203 is made of an opaque metal electrode differently from the sustain electrode pair 102, 103 shown in FIG. 1. That is, ITO which is a conventional transparent electrode material is not used, while the sustain electrode pair 202, 203 is formed by using the conventional material of the bus electrode such as Ag, Cu or Cr. That is, each sustain electrode pair 202, 203 of the plasma display panel according to the embodiment of the present invention does not include the conventional ITO electrode. The sustain electrode pair 202, 203 of the plasma display panel according to the embodiment of the present invention is made of one layer with the sole bus electrode.

For example, it is preferable that the sustain electrode pair 202, 203 according to the embodiment of the present invention is made of silver. It is preferable that the silver Ag has the photosensitivity property. Further, it is preferable that the sustain electrode pair 202, 203 according to the embodiment of the present invention is more gloomy and the permeability of the light is more low than the front dielectric layer 204 formed on the front substrate 201.

It is preferable that the thickness of the electrode lines 202a 202b, 203a, 203b range from 3 μm to 7 μm. In case the electrode lines 202a 202b, 203a, 203b are formed with a range of such thickness, with obtaining a range of resistance with which the plasma display panel can normally operate and a necessary aperture ratio, the light reflected to the front of the plasma display apparatus can be prevented from the reduction of luminance of an image resulting from the blocking of the electrode, and the capacitance of the panel is not so much increased.

Further, the phosphor coated onto the discharge cell can radiate at least one of Red, Green, and Blue, while the phosphor is coated onto the discharge cell in sequence of R, G, B in this document.

At this time, it is preferable that the size can be differently formed in sequence of R, G, B discharge cell, while the size of B discharge cell is most big. The luminance increase can be expected due to the rising of the color temperature by making the coating area of the phosphor 214 to be more big in sequence of R, G, B. The white purity of the image displayed in the panel can be improved due to the relative increment of the blue B.

Further, in the plasma display panel according to an embodiment of the present invention, the sustain electrode pair 202, 203 is made of an opaque metal electrode differently from the sustain electrode pair 102, 103 shown in FIG. 2. That is, ITO which is a conventional transparent electrode material is not used, while the sustain electrode pair 202, 203 is formed by using the conventional material of the bus electrode such as Ag, Cu or Cr. That is, each sustain electrode pair 202, 203 of the plasma display panel according to the embodiment of the present invention does not include the conventional ITO electrode. The sustain electrode pair 202, 203 of the plasma display panel according to the embodiment of the present invention is made of one layer with the sole bus electrode.

For example, it is preferable that the sustain electrode pair 202, 203 according to the embodiment of the present invention is made of silver. It is preferable that the silver Ag has the photosensitivity property. Further, it is preferable that the sustain electrode pair 202, 203 according to the embodiment of the present invention is more gloomy and the permeability of the light is more low than the front dielectric layer 204 formed on the front substrate 201. [ [symbol] ].

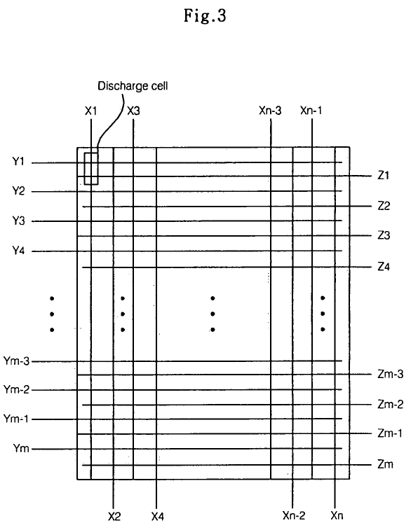

FIG. 3 is a drawing showing the embodiment of the electrode arrangement of a plasma display panel.

Referring to FIG. 3, it is preferable that a plurality of discharge cells forming a plasma display panel are positioned in the intersection of the scan electrode lines Y1 to Ym, the sustain electrode lines Z1 to Zm and the address electrode lines X1 to Xn, arranged as a matrix type. The scan electrode Y1 to Ym is sequentially drived, while the sustain electrode Z1 to Zm is commonly drived. The address electrode lines X1 to Xn is divided into even number lines and odd number lines to be drived.

The electrode arrangement shown in FIG. 3 is just an embodiment of the electrode arrangement of the plasma display panel according to the present invention. Therefore, the present invention is not restricted to the electrode arrangement of the plasma display panel and the driving method shown in FIG. 3.

For example, the dual scan mode or the double scan mode in which two scan electrode lines in the scan electrode lines Y1 to Ym are drived simultaneously can be available. Here, the dual scan method is a mode in which the plasma display panel is divided into two regions with an upper region and a lower region, while one scan electrode line which belongs to the upper region and the lower region respectively is drived simultaneously. On the other hand, the double scan mode is a mode in which two scan electrode lines which are sequentially arranged are drived simultaneously.

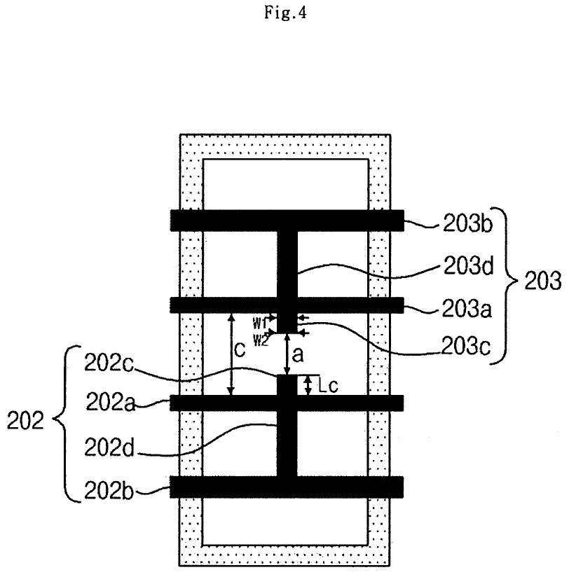

The first embodiment of the plasma display panel structure according to the present invention shown in FIG. 2 will be described in detail with FIG. 4.

FIG. 4 is a cross-sectional view showing a first embodiment of the electrode structure of a plasma display panel according to the present invention, in which only the arrangement structure of the sustain electrode pair 202, 203 formed in a discharge cell in the plasma display panel shown in FIG. 2 is briefly shown.

As shown in FIG. 4, the sustain electrodes 202, 203 according to a first embodiment of the present invention are formed as a pair to be symmetrical on the substrate based on the center of the discharge cell. Each sustain electrode is comprised of a line portion including at least two electrode lines 202a, 202b, 203a, 203b crossing the discharge cell, and a protrusion including at least one projecting electrode 202c, 203c which is protruded to the center of the discharge cell in the discharge cell and connected to the electrode line 202a, 203a which is the closest to the center of the discharge cell. Further, it is preferable that, as shown in FIG. 4, each sustain electrode 202, 203 further includes one bridge electrode 202d, 203d connecting the two electrode lines 202a and 202b, 203a and 203b.

The electrode lines 202a, 202b, 203a, 203b cross the discharge cell, and extending to the direction of the plasma display panel. The electrode line according to the first embodiment of the present invention narrowly forms a width so as to improve the aperture ratio. Further, it is preferable that a plurality of electrode lines 202a, 202b, 203a, 203b are used so as to improve the discharge diffusion efficiency while the number of electrode lines are determined in consideration of the aperture ratio.

It is preferable that projecting electrodes 202c, 203c are connected to electrode lines 202a, 203a which are closest to the center of the discharge cell in one discharge cell, and protruding to the center of the discharge cell. Projecting electrodes 202c, 203c lower the firing voltage in driving the plasma display panel.

The first embodiment of the present invention includes projecting electrodes 202c, 203c connected to each electrode line 202a, 203a since the firing voltage increases due to the distance c of the electrode line 202a, 203a. The firing voltage of the plasma display panel can be lowered, since a discharge can be generated in a low firing voltage between the projecting electrodes 202c, 203c which are formed closely. Here, the firing voltage is a voltage level where a discharge is initiated when a pulse is supplied to at least one electrode.

As to the projecting electrodes 202c, 203c, the size is very small. Therefore, due to the tolerance of the manufacturing process, the width W1 of the portion connected to electrode lines 202a, 203a of projecting electrodes 202c, 203c can be broader than the width W2 of the end portion of the projecting electrode, while, if necessary, the width W2 can be broader than the width W1.

It is preferable that the gap between two adjacent electrode lines that form a sustain electrode pair 203, 202 respectively, that is, the gap between 203a and 203b or the gap between 202a and 202b, ranges from 80 μm to 120 μm. In case the gap between two adjacent electrode lines has such value, the aperture ratio of the plasma display panel can be obtained sufficiently, the luminance of the display image can be increased, and the discharge diffusion efficiency in a discharge space can be increased.

It is preferable that the width W1 of projecting electrodes 202c, 203c ranges from 30 μm to 70 μm. In case the width W1 of projecting electrodes 202c, 203c has such value, the light reflected to the front of the plasma display apparatus can be prevented from the reduction of luminance of an image resulting from the blocking of the electrode with a small aperture ratio of the plasma display panel.

The width of the projecting electrode is formed such an extent that the discharge characteristic is not deteriorated for the rising of a luminance, while it may range from 35 μm to 45 μm to obtain the utmost aperture ratio of the panel due to a protrusion.

Further, it is preferable that the gap a of the projecting electrodes 202c, 203c ranges from 60 μm to 120 μm. In case the gapa of the projecting electrodes 202c, 203c has such value, generating too much discharges between the projecting electrodes 202c, 203c over the threshold value can be prevented not to shorten the lifetime of an electrode and a proper firing voltage can be obtained in plasma display panel driving.

That is, an over discharge or a weak discharge can be prevented when the over discharges is generated due to a small gap while the weak discharge is generated due to a remote gap, and the aperture ratio of the panel can be fully obtained.

The bridge electrode 202d, 203d connects two electrode lines 202a and 202b, 203a and 203b which form the sustain electrode 202, 203 respectively. The bridge electrode 202d, 203d helps the discharge generated through projecting electrodes 202c, 203c to be easily diffused to the electrode lines 202b, 203b which are far from the center of the discharge cell.

As to the electrode structure according to the first embodiment of the present invention, the number of electrode lines can be suggested like that, thereby, the aperture ratio can be improved. Further, the firing voltage can be lowered by forming projecting electrodes 202c, 203c. Further, the discharge diffusion efficiency is increased with electrode lines 202b, 203b and bridge electrodes 202d, 203d when electrode lines 202b, 203b are far from the center of the discharge cell. The luminous efficiency of the plasma display panel, as a whole, can be improved. That is, the brightness of the present invention is equal to the brightness of the conventional plasma display panel or brighter than the brightness of the conventional plasma display panel. Therefore, it is possible not to use an ITO transparent electrode.

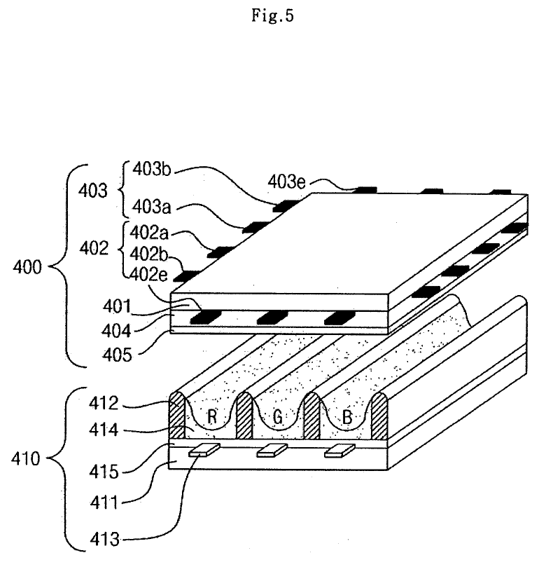

FIG. 5 is a perspective drawing showing a second embodiment of a plasma display panel according to the present invention.

As shown in FIG. 5, the second embodiment of the plasma display panel according to the present invention includes a front panel 400 and a rear panel 410 which are coalesced each other with a predetermined gap, a barrier rib 412. The address electrode 413 is formed in the rear panel 410 in the direction intersecting with a sustain electrode pair 402, 403, while the barrier rib 412 partitions off a plurality of discharge cells. Here, the same description of the content described in the first embodiment among the features of the present invention of the plasma display panel according to the second embodiment of the present invention will be omitted.

It is preferable that the sustain electrode pair 402, 403 according to the second embodiment of the present invention are made of only an opaque metal electrode. Accordingly, the manufacturing cost of the plasma display panel can be lowered. That is, it is preferable that each sustain electrode pair 402, 403 of the plasma display panel according to the present invention does not include the conventional ITO electrode, but made of one layer with the sole bus electrode.

For example, it is preferable that each sustain electrode pair 402, 203 according to the embodiment of the present invention is made of silver. It is preferable that the silver has a photosensitivity characteristic. Further, as to the sustain electrode pair 402, 403 according to the embodiment of the present invention, it is preferable that the color of which is more dark than that of the front dielectric layer 404 formed in the front substrate 401, and the permeability of the light is more low.

FIG. 5 shows the unit discharge cell R, G, B. Considering the aperture ratio and the discharge diffusion efficiency, the sustain electrode 402, 403 is formed in one discharge cell with a plurality of electrode lines. Further, in the second embodiment of the present invention, provided is the second projecting electrode 402e, 403e extended to the opposite direction of the center of the discharge cell, such that the discharge efficiency can be improved than the first embodiment of the present invention.

The structure illustrated in FIG. 5 is just an embodiment of the structure of the plasma panel according to the present invention. Therefore, the present invention is not restricted to the plasma display panel structure illustrated in FIG. 5.

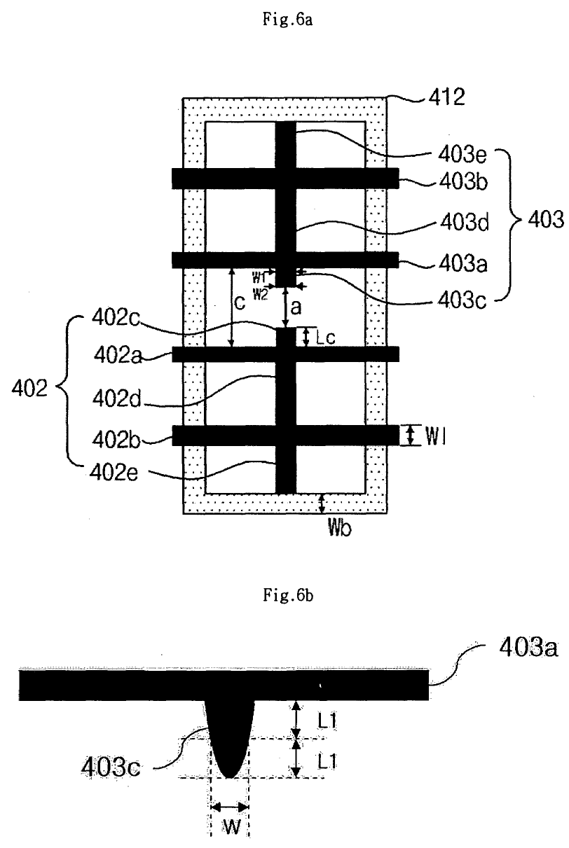

The detailed description on the structure of the sustain electrode pair 402, 403 according to the second embodiment of the present invention shown in FIG. 5 will be described in FIG. 6 to FIG. 8.

FIG. 6a to FIG. 6b is a cross-sectional view showing a second embodiment of the electrode structure of a plasma display panel according to the present invention, briefly showing only the layout structure of the sustain electrode pair 402, 403 formed in one discharge cell in the plasma display panel shown in FIG. 5.

As shown in FIG. 6a, each sustain electrode 402, 403 is comprised of at least two electrode lines 402a, 402b, 403a, 403b crossing the discharge cell, a first projecting electrode 402c, 403c which is protruded to the center of the discharge cell in the discharge cell and connected to the electrode line 402a, 403a which is the closest to the center of the discharge cell, a bridge electrode 402d, 403d connecting the two electrode lines 402a and 402b, 403a and 403b, and a second projecting electrode 402e, 403e which is protruded in the opposite direction of the center of the discharge cell in the discharge cell and connected to the electrode line 402b, 403b which is most far from the center of the discharge cell.

The electrode lines 402a, 402b, 403a, 403b cross the discharge cell, and extending to the direction of the plasma display panel. It is preferable that the electrode line according to the second embodiment of the present invention narrowly forms a width so as to improve the aperture ratio. Preferably, the width of electrode line ranges from 20 μm to 70 μm to improve the aperture ratio and easily generate a discharge.

As shown in FIG. 6a, the electrode line 402a, 403a which is close to the center of the discharge cell is connected to the first projecting electrode 402c, 403c, forming a path where a discharge diffusion is initiated with the beginning of the discharge. The electrode line 402b, 403b which is far from the center of the discharge cell is connected to the second projecting electrode 402e, 403e. The electrode line 402b, 403b which is far from the center of the discharge cell plays the role of diffusing a discharge to the peripheral of the discharge cell.

The first projecting electrode 402c, 403c is connected to the electrode line 402a, 403a which is close to the center of the discharge cell in one discharge cell, and protruding to the center of the discharge cell. Preferably, the first projecting electrode 402c, 403c is formed in the center of the electrode line 402a, 403a. The first projecting electrode 402c, 403c can effectively lower the firing voltage of the plasma display panel with forming in the center of the electrode line 402a, 403a.

It is preferable that the width W1 of the projecting electrode 402c, 403c ranges from 30 μm to 70 μm, while the gap between the projecting electrodes 402c, 403c ranges from 60 μm to 120 μm. The critical meaning of the upper limit value and the lower limit value of the width and the gap of the projecting electrode 402c, 403c will be omitted since it is identical with the description illustrated in FIG. 4.

The bridge electrodes 402d, 403d connect two electrode lines 402a and 402b, 403a and 403b forming the sustain electrode 402, 403 respectively. The bridge electrode 402d, 403d helps the generated discharge to be easily diffused to the center of the discharge cell and the remote electrode line 402b, 403b through the projecting electrode. Here, bridge electrode 402d, 403d is positioned in the discharge cell, however, if necessary, it can be formed on the barrier rib 412 partitioning the discharge cell.

Accordingly, in the second embodiment of the electrode structure of the plasma display panel according to the present invention, a discharge can be diffused to the space between the electrode line 402b, 403b and the barrier rib 412. Therefore, the luminous efficiency of the plasma display panel can be improved by increasing the discharge diffusion efficiency.

The second projecting electrodes 402e, 403e are connected to the electrode line 402b, 403b which is far from the center of the discharge cell, and protruding to the opposite direction of the center of the discharge cell. It is preferable that the length of the second projecting electrode 402e, 403e ranges from 30 μm to 100 μm.

Thus, a discharge can be effectively diffused to the discharge space which is far from the center of the discharge cell, while the aperture ratio of the panel is maintained with 25% to 45%, thereby the luminance of the display image can be improved.

In this way, in the present invention, it is preferable that the aperture ratio of the plasma display panel according to the present invention ranges from 25% to 45% so as to improve the luminance of the display image and the contrast, and to obtain the resistance value of the electrode for obtaining the drive margin of the drive panel.

At this time, it is preferable that the aperture ratio of the panel is an aperture ratio by contrast with the effective display region of a panel, that is, the region where the discharge cells which has an effect on the display image among the discharge cells of the panel are positioned.

As shown in FIG. 6a, the second projecting electrode 402e, 403e can be extended to the barrier rib 412 partitioning the discharge cell. In addition, if the aperture ratio can be fully compensated in the other part, the second projecting electrode 402e, 403e can be partly extend on the barrier rib 412 so as to much more improve the discharge diffusion efficiency.

However, in case the second projecting electrode 402e, 403e is not extended to the barrier rib 412, it is preferable that the gap between the second projecting electrode 402e, 403e and the barrier rib 412 which is adjacent to the second projecting electrode 402e, 403e is 70 μm or less.

When the gap between the second projecting electrode 402e, 403e and the barrier rib 412 is 70 μm or less, a discharge can be diffused effectively to the discharge space which is far from the center of the discharge cell.

It is preferable that, in the second embodiment of the present invention, the second projecting electrode 402e, 403e is formed in the center of electrode line 402b, 403b to evenly diffuse a discharge over the peripheral of the discharge cell.

In the meantime, in the second embodiment of the present invention, it is preferable that the width Wb of the barrier rib positioned in the direction to which the second projecting electrode 402e, 403e is extended among the barrier ribs partitioning the discharge cell is 200 μm or less.

In addition, it is preferable that a black matrix (not shown) for absorbing the external light to obtain the bright room contrast and preventing the emitted discharge light from being diffused throughout the neighboring discharge cell to display is formed on the barrier rib 412.

The width of the barrier rib 412 is suggested to be 200 μm or less, thereby, the region of the discharge cell is increased. Accordingly, the luminous efficiency can be increased, and the reduction of the aperture ratio due to the second projecting electrode can be compensated. Preferably, the width Wb of the barrier rib positioned in the direction to which the second projecting electrode is extended ranges from 90 μm to 100 μm to obtain the optimum luminous efficiency.

Further, referring to FIG. 6b, the protrusion 403c can include a curved portion having a curvature. As shown in FIG. 6b, in case the protrusion 403c is formed with a curve shape, the manufacturing process of the electrode can be more facilitated. In addition, such shape can prevent the wall charges from being excessively concentrated on a specific location in driving the panel. Accordingly, the discharge characteristic is stabilized, and the driving stability can be improved.

As shown in FIG. 6b, in case the protrusion 403c is formed with a curve shape, it is preferable that the width W of the protrusion 403c is defined as the width of the center portion of the protrusion 403c. In addition, the portion in which the bridge electrode 402d, 403d and the electrode line 402a, 403a are connected has a curvature like the protrusion 403c shown in FIG. 5b.

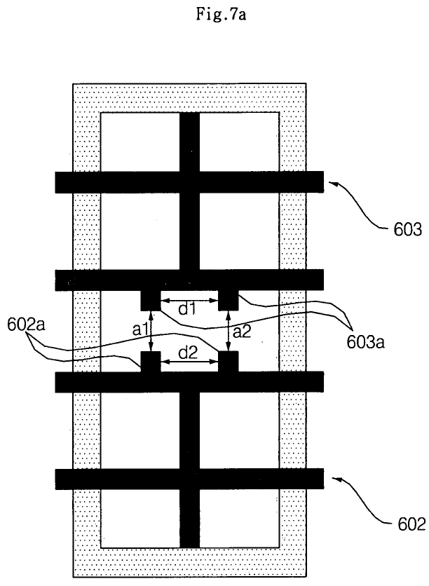

FIG. 7a to FIG. 7b are a cross-sectional view showing a third embodiment of the electrode structure of a plasma display panel according to the present invention. The same description described in FIG. 6 among the electrode structure shown in FIG. 7a to FIG. 7b will be omitted.

As shown in FIG. 7a, in the third embodiment of the electrode structure according to the present invention, two first projecting electrodes 602a, 603a are formed in the sustain electrode 602, 603 respectively. The first projecting electrodes 602a, 603a are connected to the electrode line which is close to the center of the discharge cell, and protruding to the direction of the center of the discharge cell. Preferably, each first projecting electrodes 602a, 603a is symmetrized based on the center of the electrode line to be formed.

It is preferable that the width of the first projecting electrodes 602a, 603a ranges from 30 μm to 70 μm. The critical meaning of the upper limit value and the lower limit value of the width of the projecting electrodes will be omitted since it is identical with the description illustrated in FIG. 4.

It is preferable that the gap d1, d2 of the first projecting electrodes protruded from one electrode line ranges from 50 μm to 100 μm in case the plasma display panel has the size of 42 inch with the resolution of VGA. In case the plasma display panel has the size of 42 inch with the resolution of XGA, it is preferable that the gap d1, d2 of the first projecting electrode ranges from 30 μm to 80 μm. In case the plasma display panel has the size of 50 inch with the resolution of XGA, it is preferable that the gap d1, d2 of the first projecting electrode ranges from 40 μm to 90 μm.

When the gap d1, d2 of the first projecting electrode has such range, the aperture ratio capable of implementing the luminance of the image required for the display device can be obtained. Also, the power used up in displaying can be prevented from being increased over the threshold level, when the power is increased as the reactive power due to the first projecting electrode which is so close to the barrier rib is increased.

Two first projecting electrodes 602a, 603a are formed on the sustain electrode 602, 603 such that the electrode region in the center of the discharge cell is increased. Accordingly, before a discharge is generated, the space charge is very much formed in the discharge cell, thereby, the firing voltage is more decreased, and the discharge rate is increased. Additionally, after the discharge is generated, the amount of wall charges are increased such that the luminance rises, and the discharge is uniformly diffused throughout the whole discharge cell.

It is preferable that the gap a1, a2 of the first projecting electrodes 602c, 603c, that is, the gap of two projecting electrodes in the direction intersecting with the electrode line 602, 603 ranges from 15 μm to 165 μm. The critical meaning of the upper limit value and the lower limit value of the gap of the projecting electrodes will be omitted since it is identical with the description illustrated in FIG. 4.

In the meantime, as shown in FIG. 7b, at least one of the projecting electrodes can include a portion having a curvature. For example, the end of the projecting electrode may have the shape of a curve, while the projecting electrode may have a curvature in the portion where the bridge electrode and the line electrode are adjacent. In that case, the minute shape of the projecting electrode may be readily manufactured in the manufacturing process. The discharge characteristic will be able to be improved due to the soft end processing. Additionally, in driving the PDP, the wall charges can be prevented from being excessively concentrated on a specific location. Accordingly the discharge characteristic is stabilized and the driving stability can be improved.

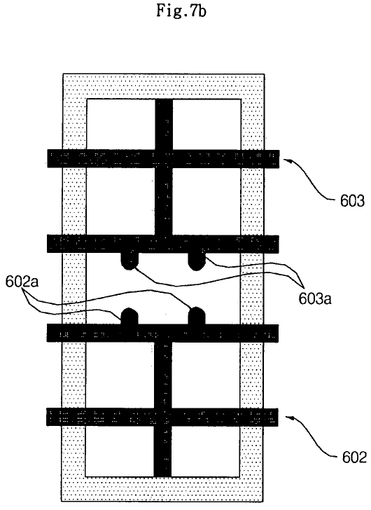

FIG. 8 is a cross-sectional view showing a fourth embodiment of the electrode structure of a plasma display panel according to the present invention. The same description described in FIG. 6, FIG. 7 among the electrode structure shown in FIG. 8 will be omitted.

As shown in FIG. 8, in the fourth embodiment of the electrode structure according to the present invention, three first projecting electrodes 702a, 703a are formed in the sustain electrode 702, 703 respectively.

The first projecting electrodes 702a, 703a are connected to the electrode line which is close to the center of the discharge cell, and protruding to the direction of the center of the discharge cell. Preferably, one of first projecting electrodes is formed in the center of the discharge cell, and the other, two electrodes, are symmetrized based on the center of the electrode line to be formed.

Three first projecting electrodes 702a 703a are formed on the sustain electrode 702, 703 respectively. Thus, the firing voltage is much more decreased than FIG. 6a and FIG. 7, and the discharge rate is much more increased. Additionally, after a discharge is generated, the luminance is much more increased, and the discharge is more uniformly diffused throughout the whole discharge cell.

As described in the above, by increasing the number of the first projecting electrode, the electrode region in the center of the discharge cell increases such that the firing voltage is decreased and a luminance increases. On the other hand, it should be considered that the brightest discharge light is emitted while the strongest discharge occurs in the center of the discharge cell. That is, by blocking the light emitted in the center of the discharge cell as the number of the first projecting electrode increases, the emitted light remarkedly reduces. Furthermore, additionally considering the firing voltage and the luminous efficiency at the same time, the most optimal number is selected to design the structure of the sustain electrode.

It is preferable that the width of the first projecting electrodes 702a, 703a ranges from 30 μm to 70 μm, while the gap a1, a2, a3 of the first projecting electrodes 702c, 703c ranges from 60 μm to 120 μm. The critical meaning of the upper limit value and the lower limit value of the gap and the width of the projecting electrodes will be omitted since it is identical with the description illustrated in FIG. 4.

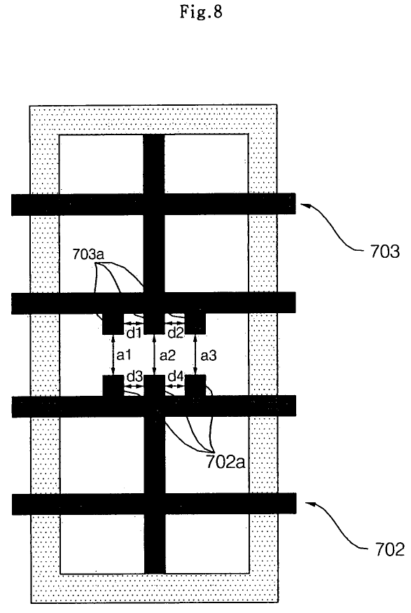

FIG. 9 is a cross-sectional view showing a fifth embodiment of the electrode structure of a plasma display panel according to the present invention.

Each sustain electrode 800, 810 includes three electrode lines 800a, 800b, 800c, 810a, 810b, 810c crossing the discharge cell. The electrode lines are extended to one direction of the plasma display panel with crossing the discharge cell. The width of the electrode lines is narrowly formed to increase the aperture ratio. Preferably, the width of the electrode lines ranges from 30 μm to 70 μm such that the aperture ratio can be improved and a discharge can be smoothly occurred.

It is preferable that the thickness of the electrode lines 800a, 800b, 800c, 810a, 810b, 810c of the sustain electrode pair ranges from 3 μm to 7 μm. The gap a1, a2 of the electrode lines of three electrode lines forming the sustain electrode can be identical or different, while the width b1, b2, b3 of the electrode lines can be identical or different.

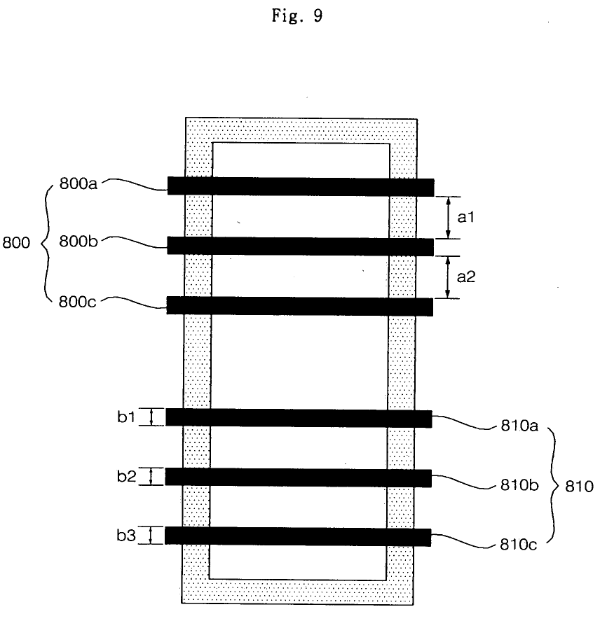

FIG. 10 is a cross-sectional view showing a sixth embodiment of the electrode structure of a plasma display panel according to the present invention.

Each sustain electrode 900, 910 includes four electrode lines 900a, 900b, 900c, 900d, 910a, 910b, 910c, 910d crossing the discharge cell. The electrode lines are extended to one direction of the plasma display panel with crossing the discharge cell. The width of the electrode lines is narrowly formed to increase the aperture ratio. Preferably, the width of the electrode lines ranges from 30 μm to 70 μm such that the aperture ratio can be improved and a discharge can be smoothly occurred.

It is preferable that the thickness of the electrode lines 900a, 900b, 900c, 900d, 910a, 910b, 910c, 910d of the sustain electrode pair ranges from 3 μm to 7 μm. The critical meaning of the upper limit value and the lower limit value of the thickness of the electrode lines will be omitted since it is identical with the description illustrated in FIG. 2.

The gap c1, c2, c3 of the electrode lines of four electrode lines forming the sustain electrode can be identical or different, while the width d1, d2, d3, d4 of the electrode lines can be identical or different.

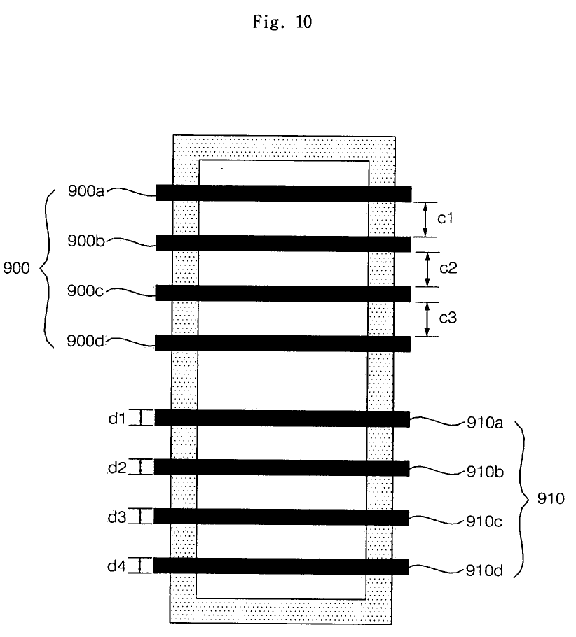

FIG. 11 is a cross-sectional view showing a seventh embodiment of the electrode structure of a plasma display panel according to the present invention.

Each sustain electrode 1000, 1010 includes four electrode lines 1000a, 1000b, 1000c, 1000d, 1010a, 1010b, 1010c, 1010d crossing the discharge cell. The electrode lines are extended to one direction of the plasma display panel with crossing the discharge cell. It is preferable that the thickness of the electrode lines 1000a, 1000b, 1000c, 1000d, 1010a, 1010b, 1010c, 1010d of the sustain electrode pair ranges from 3 μm to 7 μm. The critical meaning of the upper limit value and the lower limit value of the thickness of the electrode lines will be omitted since it is identical with the description illustrated in FIG. 2.

The bridge electrodes 1020, 1030, 1040, 1050, 1060, 1070 connect two electrode lines respectively. The bridge electrode 1020, 1030, 1040, 1050, 1060, 1070 helps the generated discharge to be easily diffused to the center of the discharge cell and the remote electrode line. As shown in FIG. 11, the location of the bridge electrodes 1020, 1030, 1040, 1050, 1060, 1070 may not coincide, while one of bridge electrodes 1040 can be positioned on the barrier rib 1080.

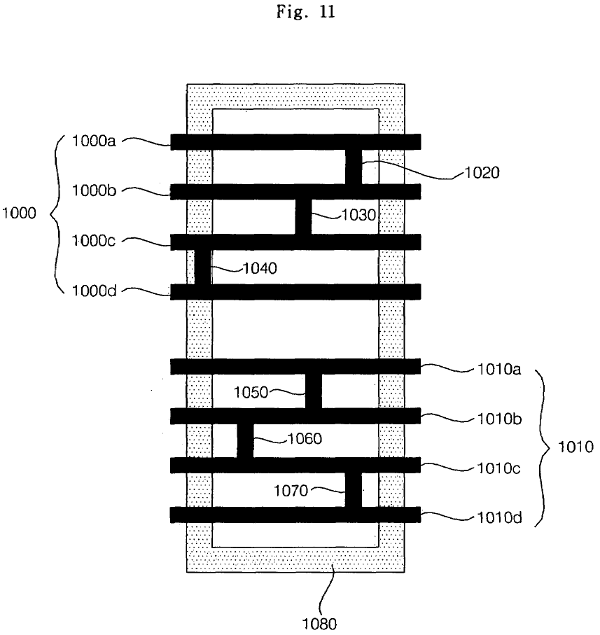

FIG. 12 is a cross-sectional view showing a eighth embodiment of the electrode structure of a plasma display panel according to the present invention. The bridge electrode connecting electrode lines is formed, differently with FIG. 11. That is, one bridge electrode 1120, 1130 connecting four electrode lines 1100a, 1100b, 1100c, 1100d, 1110a, 1110b, 1110c, 1110d to each sustain electrode 1100, 1110 is formed.

It is preferable that the thickness of the electrode lines 1000a, 1000b, 1000c, 1000d, 1010a, 1010b, 1010c, 1010d of the sustain electrode pair ranges from 3 μm to 7 μm. The critical meaning of the upper limit value and the lower limit value of the thickness of the electrode lines will be omitted since it is identical with the description illustrated in FIG. 2.

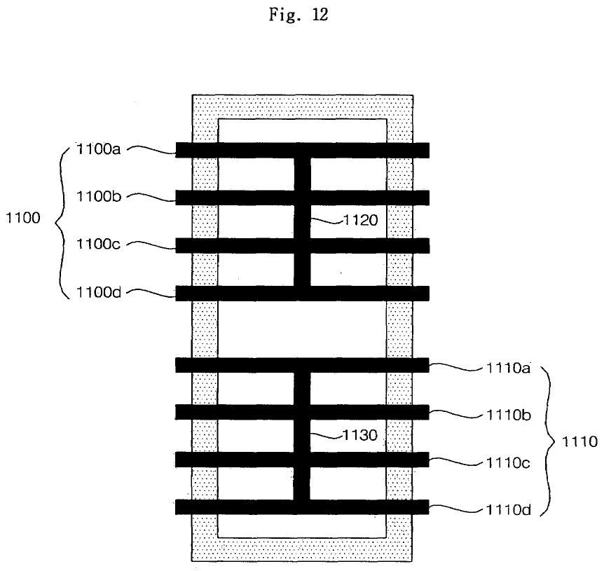

FIG. 13 is a cross-sectional view showing a ninth embodiment of the electrode structure of a plasma display panel according to the present invention.

Projecting electrodes 1220, 1230 including a closed loop for each electrode line 1200, 1210 are formed. The firing voltage can be lowered by projecting electrodes 1220, 1230 including the closed loop as shown in FIG. 13, and, at the same time, the aperture ratio can be improved. The form of the projecting electrode and the closed loop can be variously formed.

It is preferable that the thickness of the electrode lines 1200, 1210 of the sustain electrode pair ranges from 3 μm to 7 μm. The critical meaning of the upper limit value and the lower limit value of the thickness of the electrode lines will be omitted since it is identical with the description illustrated in FIG. 2.

It is preferable that the width W1, W2 of the projecting electrodes 1220, 1230 ranges from 30 μm to 70 μm. In case the width W1, W2 of the projecting electrode 1220, 1230 has such value, by obtaining a sufficient aperture ratio, the light reflected to the front of the plasma display apparatus can be prevented from the reduction of luminance of an image resulting from the blocking of the electrode,

It is preferable that the gap of projecting electrode 1220, 1230 ranges from 60 μm to 120 μm. The critical meaning of the upper limit value and the lower limit value of the gap of projecting electrode will be omitted since it is identical with the description illustrated in FIG. 4.

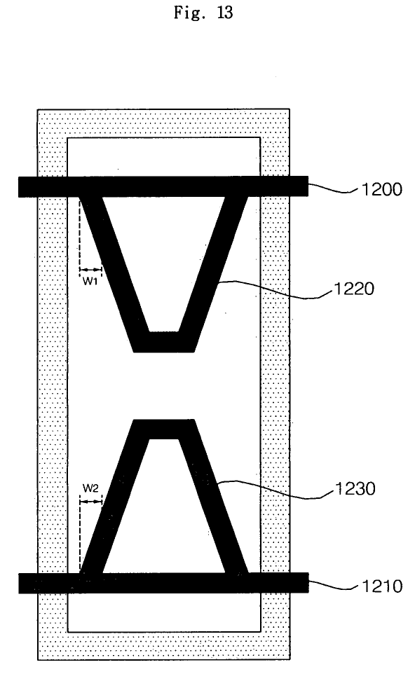

FIG. 14 is a cross-sectional view showing a tenth embodiment of the electrode structure of a plasma display panel according to the present invention.

Projecting electrodes 1320, 1330 including a rectangular loop for each electrode line 1300, 1310 are formed. It is preferable that the thickness of the electrode lines 1320, 1330 of the sustain electrode pair ranges from 3 μm to 7 μm. The critical meaning of the upper limit value and the lower limit value of the thickness of the electrode lines will be omitted since it is identical with the description illustrated in FIG. 2.

It is preferable that the width W1, W2 of the projecting electrodes 1320, 1330 ranges from 30 μm to 70 μm. The critical meaning of the upper limit value and the lower limit value of the width W1, W2 of the projecting electrodes 1320, 1330 will be omitted since it is identical with the description illustrated in FIG. 13.

It is preferable that the gap of projecting electrode 1320, 1330 ranges from 60 μm to 120 μm. The critical meaning of the upper limit value and the lower limit value of the gap of projecting electrode will be omitted since it is identical with the description illustrated in FIG. 4.

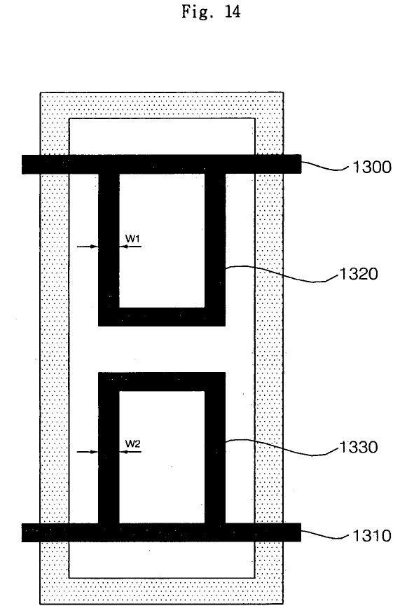

FIG. 15a and FIG. 15b are a cross-sectional view showing a eleventh embodiment of the electrode structure of a plasma display panel according to the present invention.

For each electrode line 1400, 1410, first projecting electrodes 1420a, 1420b, 1430a, 1430b protruding to the direction of the center of the discharge cell and second projecting electrodes 1440, 1450, 1460, 1470 protruding to the direction of the center of the discharge cell or in the opposite direction of the center of the discharge cell are formed.

As shown in FIG. 15a, it is preferable that, for each electrode line 1400, 1410, two first projecting electrodes 1420a, 1420b, 1430a, 1430b protruding to the direction of the center of the discharge cell are formed respectively, while one second projecting electrode 1440, 1450 protruding to the opposite direction of the center of the discharge cell is formed. Further, as shown in FIG. 15b, the second projecting electrode 1460, 1470 can be protruded to the center of the discharge cell.

It is preferable that the thickness of the electrode lines 1400, 1410 of the sustain electrode pair ranges from 3 μm to 7 μm. The critical meaning of the upper limit value and the lower limit value of the thickness of the electrode lines will be omitted since it is identical with the description illustrated in FIG. 2.

It is preferable that the width of the first projecting electrodes 1420a, 1420b, 1430a, 1430b ranges from 30 μm to 70 μm. The critical meaning of the upper limit value and the lower limit value of the width of the projecting electrodes will be omitted since it is identical with the description illustrated in FIG. 4.

It is preferable that the gap d1, d2 of the two first projecting electrodes protruded from one electrode line ranges from 50 μm to 100 μm in case the plasma display panel has the size of 42 inch with the resolution of VGA. In case the plasma display panel has the size of 42 inch with the resolution of XGA, it is preferable that the gap d1, d2 of the first projecting electrode ranges from 50 μm to 100 μm. In case the plasma display panel has the size of 50 inch with the resolution of XGA, it is preferable that the gap d1, d2 of the first projecting electrode ranges from 40 μm to 90 μm.

The critical meaning of the upper limit value and the lower limit value of the gap d1, d2 of the first projecting electrode will be omitted since it is identical with the description illustrated in FIG. 7.

It is preferable that the gap of another first projecting electrodes, that is, the gap a1 between 1420a and 1430a, or the gap a2 between 1420b and 1430b ranges from 60 μm to 120 μm. The critical meaning of the upper limit value and the lower limit value of the gap of the projecting electrodes will be omitted since it is identical with the description illustrated in FIG. 4.

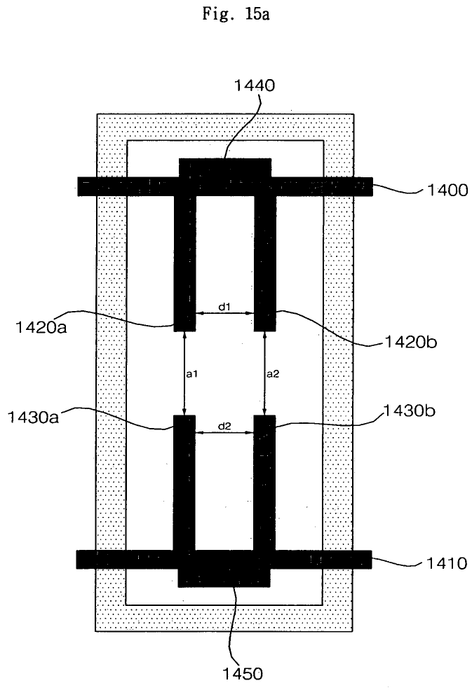

The first embodiment of the discharge cell structure of the plasma display panel according to the present invention shown in FIG. 2 will be described in detail with reference to FIG. 16 to FIG. 18.

Referring to FIG. 16, it is preferable that the first embodiment of the discharge cell structure of the plasma display apparatus according to the present invention, as shown in FIG. 16, the distance (a) between the column barrier ribs which are arranged in the both sides of R discharge cell, the distance (b) between the column barrier ribs which are arranged in the both sides of G discharge cell, and the distance (c) between the column barrier ribs which are arranged in the both sides of B discharge cell are different each other.

In that case, as to each discharge cell radiating the different color, the color temperature and the luminous efficiency can be different according to the color. Therefore, by making the size of each discharge cell to be different, the color temperature and the luminous efficiency of the discharge cells can be amended.

Table 1 shows the result of an experiment measuring the color temperature according to the size of R, G, B discharge cell, while the experiment is performed on 3 panel having the same structure.

TABLE 1

| R | G | B | A | B | C |
|---|---|---|---|---|---|
| 1.03 | 1.00 | 0.97 | 7510K | 7480K | 7540K |
| 1.00 | 1.00 | 1.00 | 7600K | 7600K | 7540K |
| 0.97 | 1.00 | 1.03 | 7670K | 7660K | 7600K |
| 0.94 | 1.00 | 1.06 | 7910K | 8200K | 8100K |
| 0.91 | 1.00 | 1.09 | 8500K | 8450K | 8470K |

Referring to Table 1, the size of G discharge cell partitioned by the barrier rib among a plurality of discharge cells is uniformly maintained, while the size of B discharge cell and R discharge cell is varied. It is seen that all of the color temperature A, B, C of the 3 panel is reduced when compared with the case in which the size of R, G, B discharge cell is all identical, in case the size of R discharge cell is 1.03 times of the size of G discharge cell such that the size of R discharge cell is greater than the size of G discharge cell, while the size of B discharge cell is 0.97 times of the size of G discharge cell such that the size of B discharge cell is smaller than the size of G discharge cell.

However, it is seen that the color temperature A, B, C of the 3 panel is gradually increases in case that the size of R discharge cell ranges from 0.91 times to 0.97 times of the size of G discharge cell, when the size of G discharge cell is uniformly maintained, such that the size of R discharge cell is smaller than the size of G discharge cell, while the size of B discharge cell ranges from 1.03 times to 1.09 times of the size of G discharge cell such that the size of B discharge cell is greater than the size of G discharge cell.

That is, it preferable that the distance (a) between the column barrier ribs partitioning R discharge cell is formed to be smaller than the distance (b) between the column barrier ribs partitioning G discharge cell. The distance (c) between the column barrier ribs partitioning B discharge cell is formed to be broader than the distance (b) between the column barrier ribs partitioning G discharge cell.

For example, the distance (a) between the column barrier ribs partitioning R discharge cell ranges from 0.80 times to 0.99 times of the distance (b) between the column barrier ribs partitioning G discharge cell, more preferably, can range from 0.91 times to 0.97 times in consideration of the size of one discharge cell in manufacturing process. Further, the distance (c) between the column barrier ribs partitioning B discharge cell ranges from 1.01 times to 1.2 times of the distance (b) between the column barrier ribs partitioning G discharge cell, preferably, can range from 1.03 times to 1.09 times in consideration of the simplicity. In that case, the size ratio of R, G, B discharge cell according to the embodiment of the present invention is the range that improves a feature when considering the color temperature of the panel, the color coordinate, and the luminance.

Referring to FIG. 16, the discharge cell structure of the plasma display panel of the present invention can have the structure of the close type in which discharge cells are partitioned with the row barrier rib 212a and the column barrier rib 212b.

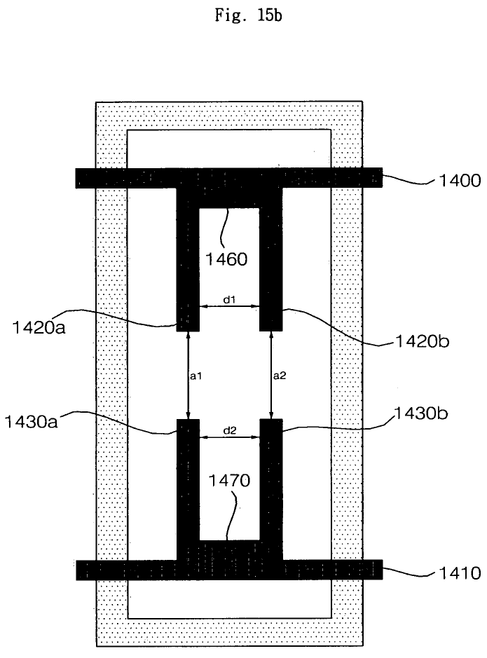

On the other hand, as shown in FIG. 17, the color temperature and the luminous efficiency of the panel can be improved, by differently forming the size of R, G, B discharge cell respectively in the plasma display panel of the channel type structure. The same description described in FIG. 16 among the discharge cell structure shown in FIG. 17 will be omitted.

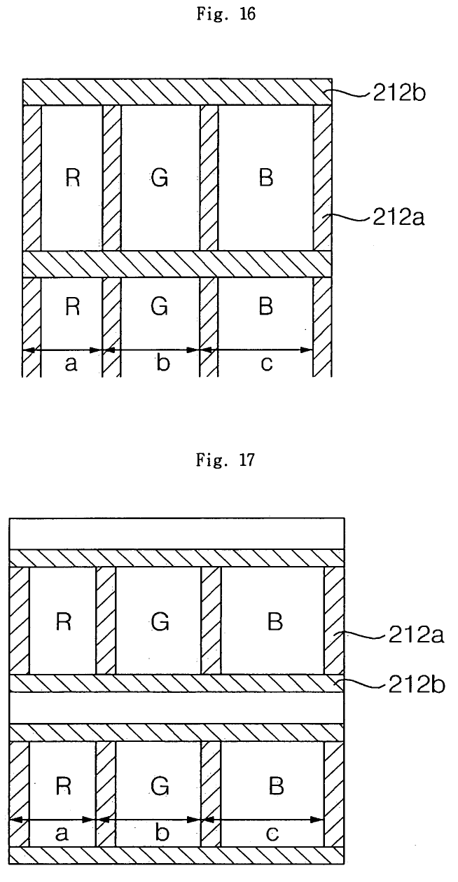

FIG. 18 is a drawing illustrating a second embodiment of the discharge cell structure of a plasma display panel of the present invention.

Referring to FIG. 18, it is preferable that, as to the plasma display panel according to the second embodiment of the present invention, R discharge cell and G discharge cell among the discharge cells partitioned with column barrier ribs 212a are formed with substantially the same size, while B discharge cell is formed with the different size with R, G discharge cell. That is, only the B discharge cell having most different color temperature characteristic is much controlled. In that way, by amending the color temperature of the panel, the overall color temperature characteristic can have a regular distribution. For example, the size (c1) of the barrier rib partitioning B discharge cell can be formed with the size of 1.01 times to 1.20 times of the size (a1) of the barrier rib partitioning G discharge cell or discharge cell. In that case, the size of B discharge cell having a low B color temperature characteristic and a low luminous efficiency can be increased so as to improve the color temperature of the image displayed by the panel, and the luminance according to the luminous efficiency. It is preferable that the size of B discharge cell ranges from 1.03 times to 1.09 times of the size of the barrier rib partitioning G discharge cell in consideration of the simplicity of the manufacturing process for one discharge cell.

In the meantime, as to the size of the discharge cell of the plasma display panel of the present invention, the size of the discharge cell can be differently determined according to the characteristic of the phosphor coated on each discharge cell, for example, the color temperature according to the color radiated by the phosphor, the luminous efficiency, and the luminance.

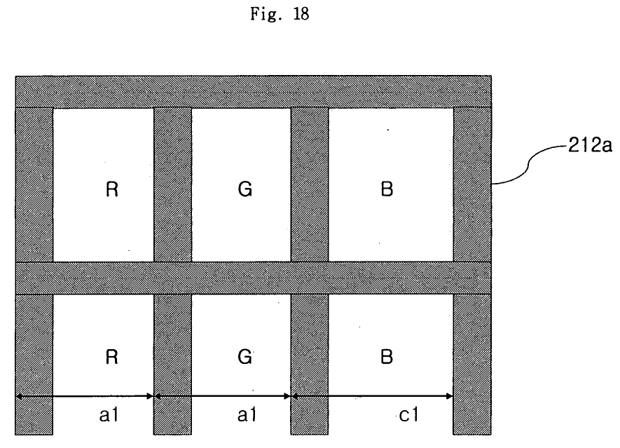

FIG. 19 is a drawing showing an embodiment of the method in which a frame of an image of a plasma display panel is time-divided into a plurality of subfields for driving.

Referring to FIG. 19, the unit frame can be time-divided driven with a predetermined number, for example, eight subfields SF1, . . . , SF8 so as to express the gray level of an image. Further, each subfield SF1, . . . , SF8 is divided into a reset period (not shown), an address period A1, . . . , A8, and a sustain period S1, . . . , S8.

In each address period A1, . . . , A8, a data signal is applied to the address electrode X, while a scan pulse corresponding to it is sequentially applied to each scan electrode Y. In each sustain period S1, . . . , S8, the sustain pulse is alternately applied to the scan electrode Y and the sustain electrode Z such that the sustain discharge is generated in discharge cells selected in the address period A1, . . . , A8.

The luminance of the plasma display panel is in proportion to the number of sustain discharge of the sustain period S1, . . . , S8 in the unit frame. In case one frame forming one image is expressed with 8 subfields and 256 gray level, the sustain pulse having a different number can be allocated to each subfield with the rate of 1, 2, 4, 8, 16, 32, 64, 128. To obtain the luminance of 133 gray level, cells are addressed to generate a sustain discharge during the subfield 1 period, the subfield 3 period, and the subfield 8 period.

In the meantime, according to the weighted value of the subfields by Automatic Power Control APC step, the number of sustain discharge allocated to each subfield can be variably determined. That is, in FIG. 19, it was exemplified that a frame is divided into 8 subfields. However, the invention is not restricted to that. Hence, the number of the subfield forming a frame can be variously changed according to the design type. For example, it can be divided into below or over 8 subfields such as 12 subfields or 16 subfields to drive the plasma display panel.

In addition, the number of sustain discharge allocated to each subfield can be variously changed in consideration of the gamma characteristics or the panel characteristics. For example, the gray level allocated to the subfield 4 can be lowered from 8 to 6, while the gray level allocated to the subfield 6 can be enhanced from 32 to 34.

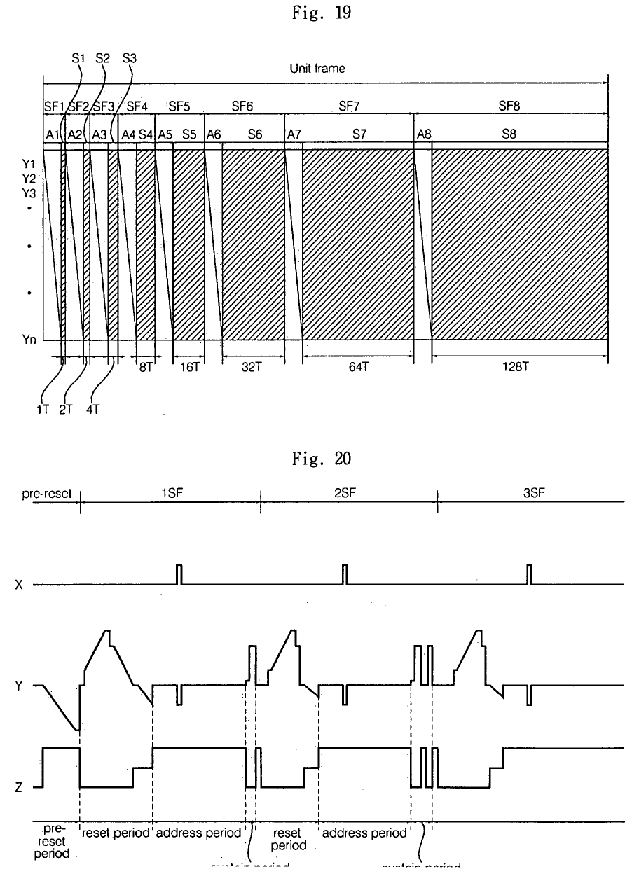

FIG. 20 is a diagram showing an embodiment of driving signals for driving a plasma display panel.

Referring to FIG. 20, the subfield SF can be divided into a reset period, an address period, and a sustain period, while the reset period can be divided again into a set up period and a set down period. In the reset period, the electric charge inside of the discharge cell is initialized. In the address period, the discharge cell in which an image is displayed or not displayed is selected. In the sustain period, the image is displayed by generating a sustain discharge in the discharge cell in which the image selected in the address period is displayed.

In the set up period, the set up signal which gradually rises is applied to the scan electrode Y such that the set up discharge is generated in all discharge cells to accumulate wall charges. In the set down period, the set down signal which gradually falls is applied to generate a weak discharge, thereby, the wall charges are uniformly remained in the discharge cell to the extent that the address discharge can be stably generated.

Further, a pre reset period exists prior to the reset period to support the sufficient forming of the wall charges. When the waveform in which the scan electrode Y voltage gradually decreases is applied prior to the reset period, the voltage of the positive polarity is applied to the sustain electrode Z to generate the pre reset discharge. It is preferable that the pre reset period exists only in the first subfield SF1 in consideration of the drive margin.

In the address period, the scan signal is sequentially applied to each scan electrode Y. Simultaneously, data signal of the positive polarity synchronized with the scan signal applied to the scan electrode Y is applied to the address electrode X. The address discharge is generated in the discharge cell by adding the difference between the voltage of the scan signal and the data signal to the wall voltage generated in the reset period such that wall charges for the sustain discharge are formed.

In the sustain period, the sustain signal is alternately applied to the scan electrode Y and the sustain electrode Z. As to the discharge cell selected by the address discharge, whenever each sustain signal is applied, the sustain discharge, that is, the display discharge occurs.

In the meantime, the waveforms shown in FIG. 20 are an embodiment of the signals for driving the plasma display panel according to the present invention. The invention is not restricted by waveforms shown in FIG. 20. For example, the reset period can be omitted in at least one subfield among a plurality of subfields forming one frame, the reset period can exist in the first subfield and the pre reset period can be omitted.

The polarity and voltage level of the driving signal shown in FIG. 21 can be changed, if necessary. The erase signal for the wall charge erase can be applied to the sustain electrode Z after the sustain discharge is completed. The single sustain drive in which the sustain signal is applied to one of the scan electrode Y and the sustain electrode Z to generate the sustain discharge can be used.

It will be apparent to those skilled in the art that various modifications and variation can be made in the present invention without departing from the spirit or scope of the present invention. Thus, it is intended that the present invention cover the modifications and variations of this invention provided they come within the scope of the appended claims and their equivalents.

What is claimed is:

1. A plasma display apparatus, comprising:
a front substrate;
a first, a second electrode formed on the front substrate;
a rear substrate that is faced with the front substrate;
a third electrodes formed on the rear substrate;
a first barrier rib formed in parallel with the third electrodes; and
a discharge cell that is partitioned by the first barrier rib,
wherein at least one of the first and the second electrode is formed with one layer,
wherein, among a plurality of discharge cells, the distance between the first barrier ribs partitioning the first discharge cell is different from the distance between the first barrier ribs partitioning the second discharge cell radiating a different color with the first discharge cell.

2. The plasma display apparatus of claim 1, wherein at least one of the plurality of the first, the second electrode comprises:
a line portion formed in the direction intersecting with the third electrode; and
a protrusion protruded from the line portion.

3. The plasma display apparatus of claim 1, further comprising a front dielectric layer covering the first, the second electrode, wherein at least one of the first and the second electrode is darker than the front dielectric layer.

4. The plasma display apparatus of claim 1, wherein the distance between the first barrier ribs partitioning the first discharge cell is shorter than the distance between the first barrier ribs partitioning the second discharge cell.

5. The plasma display apparatus of claim 1, wherein the distance between the first barrier ribs partitioning the second discharge cell ranges from 1.01 times to 1.2 times of the distance between the first barrier ribs partitioning the first discharge cell.

6. The plasma display apparatus of claim 1, wherein the distance between the first barrier ribs partitioning the second discharge cell ranges from 1.03 times to 1.09 times of the distance between the first barrier ribs partitioning the first discharge cell.

7. The plasma display apparatus of claim 1, wherein the first discharge cell is a cell radiating a red light, and the second discharge cell is a cell radiating a green light or a blue light.

8. The plasma display apparatus of claim 2, wherein the line portion is two or more, and the distance between the two line portion which are adjacent each other among the two or more line portions ranges from 80 μm to 120 μm.

9. The plasma display apparatus of claim 2, wherein the protrusion forms at least one closed loop.

10. The plasma display apparatus of claim 2, wherein the protrusion is two or more.

11. A plasma display apparatus, comprising:
a front substrate;
a first, a second electrode formed on the front substrate;
a rear substrate that is faced with the front substrate;
a third electrodes formed on the rear substrate;
a first barrier rib formed in parallel with the third electrodes; and
a discharge cell that is partitioned by the first barrier rib,
wherein at least one of the first and the second electrode is formed with one layer,
wherein the distances between the first barrier ribs partitioning a first discharge cell, a second discharge cell, and a third discharge cell respectively are different each other, when the first discharge cell is arranged to be adjacent each other among the discharge cells, the second discharge cell radiates a different color with the first discharge cell, and the third discharge cell radiates a different color with the first discharge cell and the second discharge cell.

12. The plasma display apparatus of claim 11, wherein the distance between the first barrier ribs partitioning the first discharge cell is shorter than the distance between the first barrier ribs partitioning the second discharge cell.

13. The plasma display apparatus of claim 11, wherein the distance between the first barrier ribs partitioning the second discharge cell is shorter than the distance between the first barrier ribs partitioning the third discharge cell.

14. The plasma display apparatus of claim 11, wherein the first discharge cell is a cell radiating a red light, the second discharge cell is a cell radiating a green light, and the third discharge cell is a cell radiating a blue light.

15. The plasma display apparatus of claim 11, wherein the distance between the first barrier ribs partitioning the first discharge cell ranges from 0.80 times to 0.99 times of the distance between the first barrier ribs partitioning the second discharge cell.

16. The plasma display apparatus of claim 11, wherein the distance between the first barrier ribs partitioning the third discharge cell ranges from 1.01 times to 1.2 times of the distance between the first barrier ribs partitioning the second discharge cell.

17. The plasma display apparatus of claim 11, wherein at least one of the plurality of the first, the second electrode comprises:
a line portion formed in the direction intersecting with the third electrode; and
a protrusion protruded from the line portion.

18. The plasma display apparatus of claim 11, further comprising a front dielectric layer covering the first, the second electrode, wherein at least one of the first and the second electrode is darker than the front dielectric layer.

19. The plasma display apparatus of claim 11, wherein the protrusion is two or more.

20. A plasma display apparatus, comprising:
a front substrate;
a first, a second electrode formed on the front substrate;
a rear substrate that is faced with the front substrate;
a third electrodes formed on the rear substrate;
a first barrier rib formed in parallel with the third electrodes; and
a discharge cell that is partitioned by the first barrier rib,
wherein at least one of the first and the second electrode is formed with one layer,
wherein, among a plurality of discharge cells, the distance between the first barrier ribs partitioning the first discharge cell is different from the distance between the first barrier ribs partitioning the second discharge cell radiating a different color with the first discharge cell, and
the aperture ratio in an effective display region that is formed by the first discharge cell and the second discharge cell ranges from 25% to 45%.
